(19) United States
(12) Patent Application Publication
(10) Pub. No.: US 2004/0062410 A1
(43) Pub. Date: Apr. 1, 2004

(54) Behind-the-ear housing functioning as a switch

(76) Inventors: Josef Wagner, Lachen (CH); Daniel Oertli, Rapperswil (CH)

Correspondence Address: PEARNE & GORDON LLP, 1801 EAST 9TH STREET, SUITE 1200, CLEVELAND, OH, 44114-3108, US

(21) Appl. No.: 10/212,994

(22) Filed: Aug. 5, 2002

(51) Int. Cl. H04R 25/00

(52) U.S. Cl. 381/330; 381/322

(57) ABSTRACT

A housing (3) for electrical and/or electronic microdevices, in particular hearing aids (1), encompassing at least one switchable element or switching circuit system, is provided with a pressure-sensitive, bendable and/or elastic section (11). That section is functionally connected to the said switching element or circuit system in such fashion that applying pressure on the housing or bending or deforming the elastic section (11) triggers a switching operation of the switching element or circuit system.

This invention relates to a housing for electrical and electronic microdevices, containing at least one switchable element or switching circuit system, to a hearing aid with a housing, and to a method for operating a hearing aid.

When on a hearing aid electrical or acoustic settings are to be changed, this is accomplished by means of controls on the device or by a remote control. These control elements are switches, potentiometers and the like, collectively referred to as control elements.

In view of the small dimensions of the device the control elements are quite tiny, requiring ultradexterous fingers for operating these elements. Since wearers of hearing aids are usually members of the older generation, it is often very difficult for them to manipulate such microcontrols. While a remote control unit can certainly overcome that problem, it is not always viewed as a desirable solution, and when the remote is misplaced as can easily happen, operation of the device is rendered altogether impossible.

It is therefore an objective of this invention to introduce a system for operating hearing aids whereby for instance elderly persons or even someone wearing gloves with consequently reduced dexterity can operate a hearing aid, to the extent manually possible, in simple fashion.

This objective is achieved by means of a housing for electrical or electronic microdevices, in particular hearing aids, as specified in claim 1.

According to the solution proposed, the housing such as that especially of a hearing aid, containing at least one switchable element or switching circuit system, includes a bendable and/or elastic or pressure-sensitive section that is functionally connected to the switching element or circuit in such fashion that a bending motion or compression or deformation of the elastic or pressure-sensitive section can trigger a switching operation.

Predominantly in elongated housings as commonly used for hearing aids, it is preferably a central segment or a central or end section of the housing that is constructed as a bendable or resiliently deformable region.

Especially in the case of hearing-aid housings, typically consisting of a polymer material, it is possible and desirable to produce a housing that is composed of an essentially rigid section and, as mentioned, a bendable or resiliently deformable i.e. elastic section employing so-called 2K injection molding technology. By that methodology it is possible to simultaneously produce, in one operation, both what ultimately serves as the essentially rigid, nonresilient polymer and the bendable or elastically deformable polymer, especially an elastomer, by simultaneous injection in one single mold.

Other preferred implementation variants of the housing according to this invention, in particular of a housing for hearing aids, are characterized in the subclaims.

Also proposed is a method for operating a hearing aid utilizing a housing as defined in this invention. According to the invention, bending or deforming the bendable of resiliently compressible section can trigger or change specific functions within the hearing aid.

In one design variant, it is possible to activate different functions depending on the way and the duration of such activation, functions such as switching the hearing aid on and off, adjusting the volume, compensating for ambient noise, etc.

The hearing aid is preferably operated by applying one's fingers, for instance the index finger and the thumb, to corresponding end sections of the hearing-aid housing.

The following will explain this invention in more detail based on a design example and with reference to the attached drawing in which—

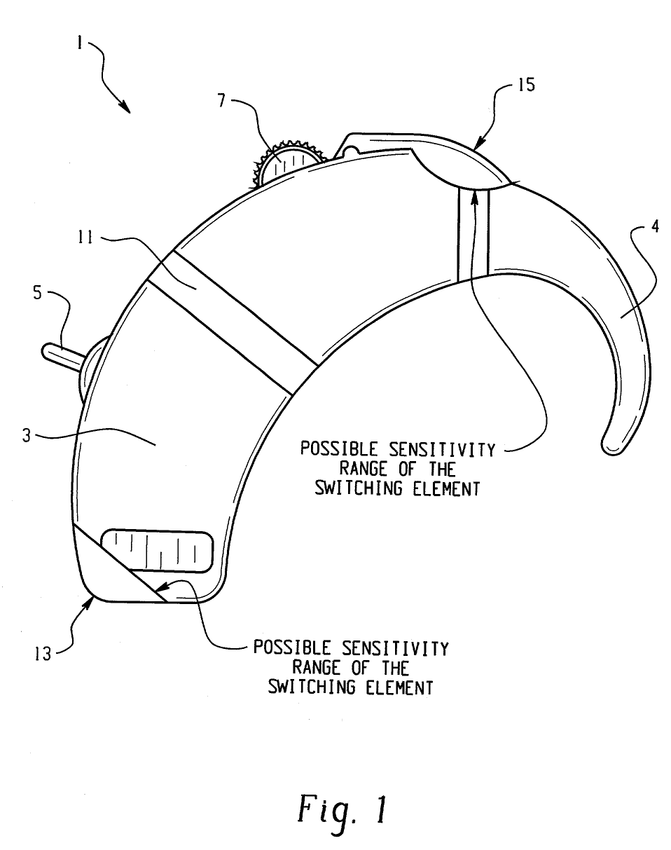

FIG. 1 illustrates a hearing aid, i.e. the housing of a hearing aid, according to this invention.

The hearing aid 1 shown in FIG. 1 encompasses a so-called behind-the-ear housing primarily including an inflexible, rigid housing section 3 and terminal bracket 4 designed to permit positioning of the hearing aid behind the ear. For the operation of the hearing aid the housing is equipped with different switching elements such as an on/off switch 5 or a volume control 7. Because of the ultra-small dimensions of these two switching elements it is evident that operating the hearing aid depicted in FIG. 1 is possible only if the wearer has the necessary micromotorial dexterity, failing which it would be difficult at best to operate these controls.

This invention therefore proposes the positioning of a bendable or resiliently deformable section 11 in the central area of the housing 3, which can be bent or compressed by applying pressure at the two actuating pressure points 13 and 15. For example, the index finger may push against pressure point 15, the thumb against point 13. Bending the hearing-aid housing causes the hearing aid to be switched on or off. Extending the duration of the bending or compressive deformation of the center section of the housing 3 may serve for volume control, as an example. It would also be possible by means of a double bending action to access different functions within an electronic menu.

Of course, a variety of other conceptual embodiments of the hearing aid are possible, for instance by positioning pressure-sensitive elements or switches, designed to trigger different functions, in the bendable section. As another possibility, the elastomer may be made electrically conductive, allowing additional functions to be activated by a manipulation or deformation of the elastic section.

It is equally possible, however, for the two regions 13 and 15, serving as pressure points actuated by the application of finger pressure, to be made electrically conductive through the use of an electrically conductive polymer. This would add another functional capability for instance by touching both regions 13 and 15 at the same time.

The big advantage of the hearing-aid housing illustrated in FIG. 1 is its ease of operation, in that the dimensions of the housing constituting the operating controls fairly match the size of the human finger, making for convenient manipulation. The actuators can be integrated in the housing so that it is possible for instance to eliminate altogether the controls 5 and 7, shown in FIG. 1, which obviates the need for providing the housing with openings for these controls. This also keeps out undesirable environmental factors such as humidity and the like.

1. Housing for electrical and/or electronic microdevices, encompassing at least one switchable element or switching circuit system, characterized by a pressure-sensitive, bendable and/or elastic section (11) designed to act as an energy-transferring component and functionally connected to the switching element or circuit in such fashion that an application of pressure on the housing or a deformation of the elastic section can trigger a switching operation.

2. Housing as in claim 1, characterized in that the housing body (3) is designed as an oblong object and that the said section (11) is preferably located or created in the central region of the housing body (3).

3. Housing as in claim 1 or 2, characterized in that, at the ends of the housing body (3) on opposite sides relative to the section (11), actuating pressure points (13, 15) are provided which, when subjected to pressure applied manually or with a tool, can produce a bending motion or a deformation.

4. Housing as in one of the claims 1 to 3, characterized in that the deformable or bendable section (11) and/or the actuating points (13, 15) to be subjected to pressure are made of an electrically conductive polymer.

5. Housing as in one of the claims 1 to 4, characterized in that the housing body (3) and the section (11) consist of polymer materials having different moduli of elasticity, allowing the housing body and the elastic section to be produced by the so-called 2K injection molding method.

6. Hearing aid equipped with a housing as per one of the claims 1 to 5.

7. Hearing aid as in one of the claims 1 to 6, characterized in that the housing itself can be actuated to function as a switch in that the bendable or resiliently deformable section, preferably extending in a transverse direction in the center of the hearing-aid housing body (3), is bent or deformed.

8. Hearing-aid housing as in one of the claims 1 to 7, characterized in that it is designed as a behind-the-ear hearing-aid housing curved to follow the anatomy of the auricula and is preferably provided in its central region with a bendable or elastically deformable, strip-shaped section (11) extending in a direction perpendicular to the longitudinal axis of the housing.

9. Method for operating a hearing aid encompassing a housing as per one of the claims 1 to 8, characterized in that bending or deforming the bendable or elastically deformable section serves to trigger or change one or several functions.

10. Method as in claim 9, characterized in that by selecting the mode and duration of the actuation, different functions such as on/off, volume control and others can be chosen.

11. Method as in claim 9 or 10, characterized in that for the actuation a finger is applied to each end of the hearing-aid housing.
